(19) United States
(12) Patent Application Publication
(10) Pub. No.: US 2005/0223051 A1
(43) Pub. Date: Oct. 6, 2005

(54) System for building structured spreadsheets using nested named rectangular blocks of cells to form a hierarchy where cells can be uniquely referenced using non unique names

(76) Inventor: Gary Kazuo Arakaki, Tokyo (JP)

Correspondence Address: GARY K. ARAKAKI, SEIO HILLS 401, 4-6-10 OGIKUBO, SUGINAMI-KU, TOKYO, 167, JP

(21) Appl. No.: 10/906,978

(22) Filed: Mar. 15, 2005

Related U.S. Application Data
(60) Provisional application No. 60/521,339, filed on Apr. 5, 2004.

(51) Int. Cl. G06F 7/38

(52) U.S. Cl. 708/490

(57) ABSTRACT

This system is a way of building structured spreadsheets using named nested rectangular block of cells to form a hierarchy. This system allows cells to be referenced by non unique names by using the relative location in the hierarchy of the referenced cell with respect to the cell containing the reference. Clones of a section of the hierarchy can be constructed. The clones are permanently linked to the section of the hierarchy from which they were cloned. Future changes to that section of the hierarchy can be propagated to the clones.

### BACKGROUND OF THE INVENTION

Spreadsheets are very useful but very prone to errors. This is really a direct consequence of the way spreadsheet applications allow users to build spreadsheets. Although, there are methodologies that users can follow which will help them to build more reliable spreadsheets, it is very likely that spreadsheets will continue to be built without using these methodologies as it is unreasonable to expect that average user will be conversant with these methodologies. It may be better if spreadsheet users were given a new easy way of building spreadsheets that naturally forces the spreadsheets to be built in a way that is conducive to preventing many of the errors from occurring. The basic technology for building spreadsheets has not changed for a very long time. In the meantime computers have become vastly more powerful. These vastly more powerful computers makes it is possible to consider innovative new ways of building spreadsheets that were impractical on the earlier generations of computers.

### BRIEF SUMMARY OF THE INVENTION

The present invention provides the user with system of building structured spreadsheets that automatically eliminates many of the errors that would be caused by incorrect cell references in formulas and by incorrect replication of cells. Structuring the spreadsheet allows the present invention to provide alternatives to three basic spreadsheet features: relative references, the SUM spreadsheet function and the copy and paste operation. Although, much of the power of spreadsheets is derived from using these three features, using these three features to build spreadsheets also make it easy to produce spreadsheets with errors. The present invention provides alternatives to these three features that automatically make it much harder to produce spreadsheets with errors. The present invention supports localized references, an alternative to relative references, the SUMNAMED spreadsheet function, an alternative to the SUM spreadsheet function and the clone operation, an alternative to the copy and paste operation. These new capabilities are made possible by structuring the cells on a spreadsheet into regions bound to symbolic names. Localized references are used to reference cells by their symbolic name and their containing regions. The SUMNAMED spreadsheet function selectively sums the values of some of the cells in a specified region using the symbolic names of the cells to select the cells to sum. Cloning creates a clone of a progenitor region. The clone and the progenitor are permanently linked so that the cells of the cloned region can be synchronized with the cells of the progenitor after the progenitor has been edited.

### BRIEF DESCRIPTION OF THE SEVERAL VIEWS OF THE DRAWING

FIG. 1 is a screen shot of a spreadsheet illustrating two examples of localized referencing.

FIG. 2 is a screen shot of a spreadsheet containing a clone and its progenitor before the progenitor has been edited.

FIG. 3 is a screenshot of the spreadsheet of FIG. 2 after the progenitor has been edited and the clone synchronized with its progenitor.

FIG. 4 is a screenshot of a spreadsheet illustrating the use of the SUMNAMED function.

FIG. 5 is a screenshot of a spreadsheet illustrating the use of planes.

### DETAILED DESCRIPTION OF THE INVENTION

This system uses regions to structure the cells on a spreadsheet. A region is a rectangular block of cells bound to a symbolic name. A region may completely contain another region or be completely contained in another region but a region may not partially overlap another region. Therefore with respect to containment the regions of a spreadsheet form a tree hierarchy where the region consisting all cells of the spreadsheet is the root of the tree hierarchy. A single cell may be a region. A container is a region of more than one cell. A region that is contained in a container is said to be a member of that container. Multiple regions may have the same symbolic name. A symbolic name in this system is not intended to uniquely identify a region but rather, a symbolic name really specifies the type of data contained in a region. This slight paradigm shift will make names much more useful in formulas as we will soon see. The regions should be chosen to correspond to natural hierarchy of the underlying data in the regions of the spreadsheet. For example, the regions may organize the cells of the spreadsheet geographically by city, state and country.

A formula in a cell may be able reference another cell by its symbolic name. However, since multiple cells may have the same symbolic name another condition is necessary to give uniqueness. The basic idea behind the technique that this system uses to resolve the ambiguity of multiple cells having the same symbolic name is to select the cell with the specified symbolic name that has the same locality as the cell containing the formula referencing the cell by symbolic name. Specifically, if multiple cells have the specified symbolic name then the cell in the smallest region that contains both the cell with the formula and a cell with the specified symbolic name is selected as the referenced cell. In other words, the system searches successive nested containers of the cell containing the formula beginning with the smallest (innermost) container until a container is found that contains a cell with the specified symbolic name. If the found container contains more than one cell with the specified name then the system will display an error message and the user will need to redesign the spreadsheet so that references can be uniquely resolved. This way of referencing cells will be referred to as localized referencing. Note that if a region is copied and pasted then the localized references in formulas naturally references the corresponding cells in the new locality. This provides the same capability as relative cell references but uses user friendly names instead of relative addresses.

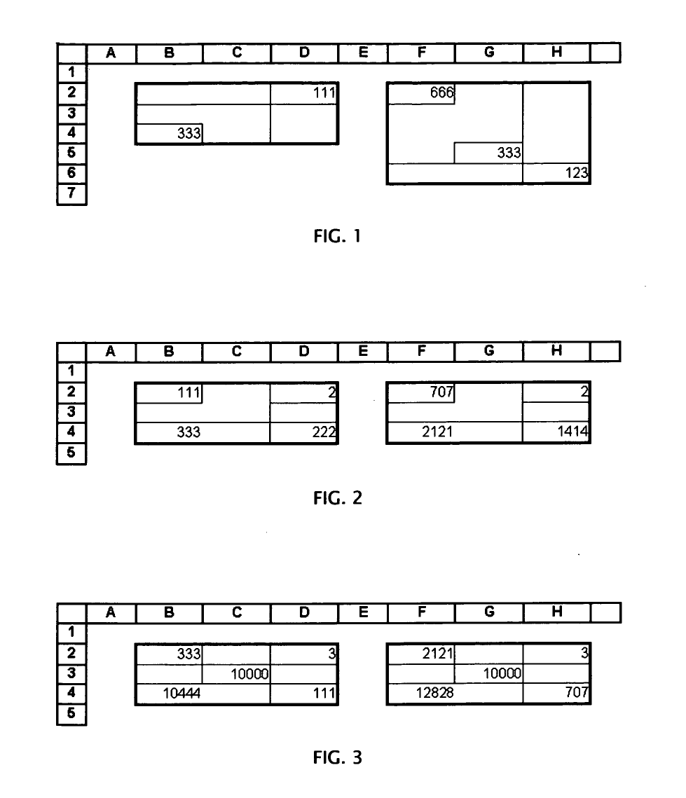

An example will make this clear. FIG. 1 shows a spreadsheet containing regions. The following below describes the regions and cell contents of the spreadsheet in FIG. 1.

| Range | Name | Contents |
|---|---|---|
| B2:D4 | AAA | |
| B3:C4 | BBB | |
| B4 | CCC | =3*DDD |
| D2 | DDD | 111 |
| F2:H6 | XXX | |
| F2:G5 | YYY | |
| F2 | ZZZ | =2*DDD |
| G5 | DDD | 333 |
| H6 | DDD | 123 |

To resolve the localized reference “DDD” in the formula “=3*DDD” contained in the cell B4 The system first searches the region named “BBB” (B3:C4) which is the smallest container containing the cell B4 for a cell named “DDD” and does not find one. Then the system searches the region named “AAA” (B2:D4) which is the next smallest container containing the cell B4 for a cell named “DDD” and finds the cell D2. Thus the localized reference “DDD” in the formula “=3*DDD” contained in cell B4 is resolved to the cell D2. The localized reference “DDD” in the formula “=2*DDD” contained in the cell F2 is resolved to the cell G5 and not to the cell H6 since the region named “YYY” (F2:G5) is smaller than the region named “XXX” (F2:H6).

A region may be cloned. The original region is called the progenitor. Each cell of the progenitor may be designated as a propagating cell or as a non-propagating cell by the user. After a clone is created the cells of the clone that correspond to non-propagating cells of the progenitor may be modified by the user to customize the clone. A clone is said to be synchronized with its progenitor if the clone has exactly the same member regions at exactly the same relative locations as the progenitor and the contents of all propagating cells of the progenitor are identical to the contents of the corresponding cells of the clone. The contents of a cell is the formula if a cell contains a formula otherwise it is the value of the cell. A clone is permanently linked with its progenitor and a clone can always be synchronized with its progenitor after the progenitor has been edited. After the progenitor has been edited and upon a user request to synchronize the clones with the edited progenitor, the system will propagate to the clones of the progenitor only some of the modifications that have been done to the progenitor during editing and at the same time preserving some of the original contents in the clone. Specifically, changes to the size and/or relative position of member regions contained in the progenitor are propagated to the clones of the progenitor. The size, position and contents of newly created member regions contained in the progenitor are propagated to the clones of the progenitor. Member regions of the clones that correspond to deleted previously existing member regions of the progenitor are deleted from the clones by unbinding those regions from their symbolic name. The contents of the propagating cells of the progenitor are propagated to the corresponding cells of clones of the progenitor. Other cells in the clones of the progenitor will have their contents preserved. The system guarantees that the cells in a clone that correspond to propagating cells in the progenitor will always have the same contents as the corresponding cells in the progenitor. The system will not allow the user to edit a cell in a clone that corresponds to a propagating cell in the progenitor. Hence, the user never needs to worry that a cell in a clone that is propagated to may have an inadvertent wrong value. In particular, the user only needs to check cells that are not propagated to when verifying his spreadsheet. The system can highlight the cells that are not propagated to to make the checking easier. This greatly reduces the effort needed to verify a spreadsheet.

An example will make this clear. FIG. 2 shows a spreadsheet containing a clone and its progenitor before the progenitor has been edited. The following table describes the regions and cell contents of the spreadsheet in FIG. 2.

| Range | Name | Contents | Propagating |
|---|---|---|---|
| B2:D4 | AAA | | |
| B2:C3 | BBB | | |
| B2 | CCC | 111 | no |
| D4 | DDD | =EEE*CCC | yes |
| D2 | EEE | 2 | yes |
| B4 | | =CCC+DDD | yes |
| F2:H4 | AAA | | |
| F2:G3 | BBB | | |
| F2 | CCC | 707 | |
| H4 | DDD | =EEE*CCC | |
| H2 | EEE | 2 | |
| F4 | | =CCC+DDD | |

The region F2:H4 is a clone of the progenitor at B2:D4. Since the cells D4, D2 and B4 of the progenitor are propagating cells the corresponding cells H4, H2 and F4 of the clone have identical contents. Note that if a propagating cell in the progenitor contains a formula the corresponding cell in the clone contains the identical formula but not necessarily the same value.

FIG. 3 shows the spreadsheet of FIG. 2 after the progenitor has been edited and the clone has been synchronized. The following table describes the regions and cell contents of the spreadsheet in FIG. 3.

| Range | Name | Contents | Propagating |
|---|---|---|---|
| B2:D4 | AAA | | |
| B2:B3 | BBB | | |
| D4 | CCC | 111 | no |
| B2 | DDD | =EEE*CCC | yes |
| D2 | EEE | 3 | yes |
| C3 | FFF | 10000 | no |
| B4 | | =CCC+DDD+FFF | yes |
| F2:H4 | AAA | | |
| F2:F3 | BBB | | |
| H4 | CCC | 707 | |
| F2 | DDD | =EEE*CCC | |
| H2 | EEE | 3 | |
| G3 | FFF | 10000 | |
| F4 | | =CCC+DDD+FFF | |

The progenitor “AAA” at B2:D4 has been edited as follows: The region “CCC” at B2 was moved to D4. The region “DDD” at D4 was moved to B2. The region “BBB” at B2:C3 was shrunk to B2:B3. The content of cell D2 was changed from “2” to “3”. The region “FFF” was created at C3 with content “10000”. The content of cell B4 was changed from “CCC+DDD” to “CCC+DDD+FFF”. After synchronization the clone changes as follows: The region “CCC” at F2 moves to H4. The region “DDD” at H4 moves to F2. The region “BBB” at F2:G3 shrinks to F2:F3. The content of cell H2 changes from “2” to “3”. The region “FFF” is created at G3 with content “10000”. The content of cell F4 changes from “=CCC+DDD” to “=CCC+DDD+FFF”. Note that the content of the region “CCC” in the clone is unchanged since the corresponding cell in the progenitor is not a propagating cell.

The system provides a spreadsheet function called SUMNAMED for use in cell formulas. SUMNAMED takes two arguments: the first argument is a pattern for matching symbolic names and the second argument is the name of a container. SUMNAMED will sum the value of all cells that are contained in the container specified by the second argument and have symbolic names that matches the pattern specified by the first argument. The specified container is the smallest container that has the specified symbolic name and contains the cell that contains the formula that has the SUMNAMED expression. The pattern is a regular expression. Although a container may contain cells of many different types, SUMNAMED will sum the value of only those cells in the container with names that match the specified regular expression. For example detail items and subtotals may be contained in the same container but only the detail items may be selectively summed to obtain a grand total if the names of the detail items and the names of the subtotal items can be differentiated by a regular expression.

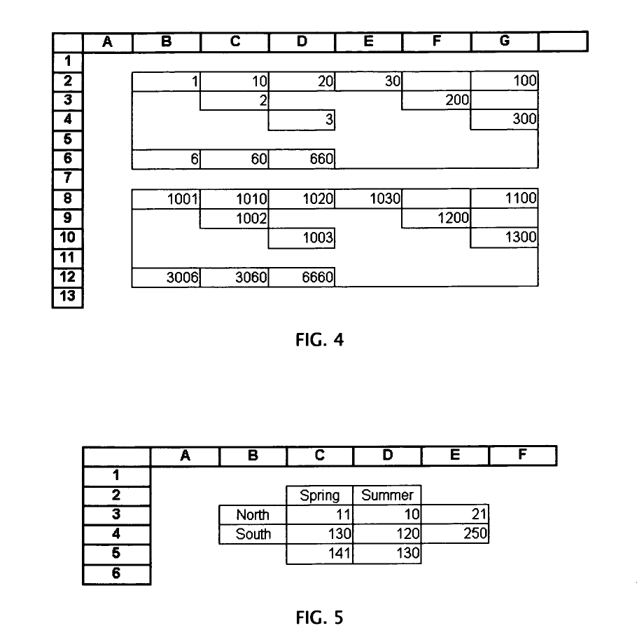

An example will make this clear. FIG. 4 shows a spreadsheet illustrating the use of the SUMNAMED function. The following table describes the regions and cell contents of the spreadsheet in FIG. 4.

| Range | Name | Contents |
|---|---|---|
| B2:G6 | AAA | |
| B2 | BBB | 1 |
| C3 | BBB | 2 |
| D4 | BBB | 3 |
| C2 | CCC1 | 10 |
| D2 | CCC2 | 20 |
| E2 | CCC3 | 30 |
| G2 | DDD1 | 100 |
| F3 | DDD2 | 200 |
| G4 | DDD3 | 300 |
| B6 | EEE1 | =SumNamed(“BBB”,“AAA”) |
| C6 | EEE2 | =SumNamed(“CCC.+”,“AAA”) |
| D6 | EEE3 | =SumNamed(“(CCC.+)\|(DDD.+)”,“AAA”) |
| B8:G12 | AAA | |
| B8 | BBB | 1001 |
| C9 | BBB | 1002 |
| D10 | BBB | 1003 |
| C8 | CCC1 | 1010 |
| D8 | CCC2 | 1020 |
| E8 | CCC3 | 1030 |
| G8 | DDD1 | 1100 |
| F9 | DDD2 | 1200 |
| G10 | DDD3 | 1300 |
| B12 | EEE1 | =SumNamed(“BBB”,“AAA”) |
| C12 | EEE2 | =SumNamed(“CCC.+”,“AAA”) |
| D12 | EEE3 | =SumNamed(“(CCC.+)\|(DDD.+)”,“AAA”) |

The formula “=SUMNAMED(“BBB”,“AAA”)” in cell B6 sums all the cells with name “BBB” in the container named “AAA” at B2:G6 (This is the smallest container named “AAA” that contains the cell B6.) which are the cells B2, C3 and D4. The formula “=SUMNAMED(“CCC.+”, “AAA”) in cell C6 sums all the cells that have names beginning with “CCC” in the container named “AAA” at B2:G6 which are the cells C2, D2 and E2. The formula “=SUMNAMED(“(CCC.+)|(DDD.+)”,“AAA”) sums all the cells that have names beginning with “CCC” or “DDD” in the container named “AAA” at B2:G6 which are the cells C2, D2, E2, G2, F3 and G4. The formulas in the container named “AAA” at B8:G12 (This container is a clone of the container at B2:G6.) sum the respective cells in this container. Note that the formulas are the same in both containers but they automatically reference cells in their respective containers.

The same data may naturally be classified into multiple different hierarchies simultaneously. For example the data may be classified geographically by city, state and country and simultaneously classified by time by day, month, quarter and year. This system supports multiple hierarchies on the same spreadsheet using planes. Each spreadsheet has four planes: Main, Aux1, Aux2 and Aux3. Each plane supports one hierarchy. When trying to resolve a reference to a region this system searches all the containers of the cell that has the formula with the reference in all the planes in order by size smallest first until the reference is resolved.

An example will make this clear. FIG. 5 shows a spreadsheet with two planes: Main and Aux1. The following table describes the regions and cell contents of the spreadsheet in FIG. 5.

| Range | Name | Contents | Plane |
|---|---|---|---|
| C3 | AMOUNT | 11 | Main, Aux1 |
| C4 | AMOUNT | 130 | Main, Aux1 |
| D3 | AMOUNT | 10 | Main, Aux1 |
| D4 | AMOUNT | 120 | Main, Aux1 |
| C2:C5 | SEASON | | Main |
| D2:D5 | SEASON | | Main |
| B3:E3 | REGION | | Aux1 |
| B4:E4 | REGION | | Aux1 |
| C5 | | =SumNamed(“AMOUNT”, | |
| | | “SEASON”) | |
| D5 | | =SumNamed(“AMOUNT”, | |
| | | “SEASON”) | |
| E3 | | =SumNamed(“AMOUNT”, | |
| | | “REGION”) | |
| E4 | | =SumNamed(“AMOUNT”, | |
| | | “REGION”) | |

The Main plane contains regions for the seasons: Spring and Summer. The Aux1 plane contains regions for the geographical regions: North and South. The “SEASON” regions (C2:C5 and D2:D5) and the “REGION” regions (B3:E3 and B4:E4) cannot exists in the same plane since they partially overlap. The reference to “SEASON” in the formula “=SUMNAMED(AMOUNT, SEASON)” in cell C5 is resolved to the “SEASON” region at C2:C5 since that region is the smallest region named “SEASON” that contains the cell C5.

1. In a multi dimensional spreadsheet wherein the formulas in cells can reference other cells by symbolic names, a method for determining the cell that is referenced by a symbolic name in a formula in a cell comprising:
a) defining a plurality of regions by binding a non-unique symbolic name to a cell or a plurality of cells for each region; and
b) for a reference to a cell by symbolic name in a formula in a cell, determining the referenced cell by searching the regions that contain the cell that has the formula for a cell that is bound to the symbolic name.

2. The method according to claim 1, wherein b) comprises the steps of:
a) finding all the regions that contain the cell that has the formula and putting those regions into a list;
b) sorting the regions in the list of a) so that a region that is contained in another region is in the list before the region that contains it;
c) searching in order each region in the ordered list of b) for a cell that is contained in that region and that is bound to the said symbolic name; and
d) selecting the first cell found in c) as the referenced cell.

3. A computer readable medium having stored thereon computer-executable instructions for performing the method of claim 2.

4. In a multi dimensional spreadsheet wherein a region is a cell or a plurality of cells bound to a symbolic name, a method for creating one or a plurality of clone regions from a progenitor region comprising:
a) creating at an origin specified by the user a clone region of a progenitor region;
b) according to user selection, designating one or a plurality of the cells of the progenitor region as propagating; and
c) in response to a user request, propagating certain types of changes done to a progenitor region to the clone regions of that progenitor region after the progenitor region has been edited by the user.

5. The method according to claim 4, wherein a) comprises the steps of:
a) binding a region at the origin of the same size and shape as the progenitor region to the same symbolic name as the progenitor region;
b) copying the contents of the cells of the progenitor region to the corresponding cells of the clone region;
c) for each region contained in the progenitor region, binding the region contained in the clone region at the same relative offset with respect to the origin of the clone region as the relative offset of the region contained in the progenitor region with respect to the origin of progenitor region and having the same size and shape as the region contained in the progenitor to the same symbolic name as the region contained in the progenitor; and
d) creating a link from the progenitor region to the clone region.

6. The method of claim 5 wherein:
a) the corresponding cells in two regions are a cell in the first region and a cell in the second region such that they have same relative offset with respect to the origin of their respective regions; and
b) wherein the contents of a cell is the formula if the cell contains a formula otherwise it is the value of the cell.

7. A computer readable medium having stored thereon computer-executable instructions for performing the method of claim 5.

8. The method of claim 4 wherein c) comprises the steps of:
a) if the size or shape of the progenitor has changed after editing, changing the size and shape of the clone to the same size and shape as the progenitor after editing;
b) if the size or shape of the progenitor has changed after editing, copying the contents of the cells of the clone before its size and shape was changed to the corresponding cells of the changed clone if a corresponding cell exists in the changed clone;
c) if the size or shape of the progenitor has changed after editing, copying the contents of the cells of the progenitor after editing to the corresponding cells of the changed clone if the changed clone does not have a corresponding cell in itself before it was changed;
d) for each region contained in the progenitor before editing and after editing, changing the location, size and shape of the corresponding region in the clone so that the changed region in the clone has the same relative offset with respect to the origin of clone as the relative offset of the region contained in the progenitor after editing with respect to the origin of progenitor after editing and has the same size and shape as the region contained in the progenitor after editing;
e) for each region contained in the progenitor before editing but does not exists after editing, unbinding the corresponding region in the clone from its symbolic name;
f) for each region of the clone changed by step d), copying the contents of the cells of itself before its location, size and shape was changed to the corresponding cells of the changed region of the clone for those cells of the changed region of the clone that has a corresponding cell in the changed region of the clone before its location, size and shape was changed;
g) for each region of the clone changed by step d), copying the contents of the cells of the corresponding region of the progenitor after editing to the corresponding cells in the changed region of the clone for those cells in the changed region of the clone that do not have a corresponding cell in the changed region of the clone before its location, size and shape was changed;
h) for each region contained in the progenitor after editing but did not exists before editing, binding the region contained in the changed clone at the same relative offset with respect to the origin of the changed clone as the relative offset of the region contained in the progenitor after editing with respect to the origin of progenitor after editing and having the same size and shape as the region contained in the progenitor after editing to the same symbolic name as the region contained in the progenitor after editing;
i) for each region contained in the progenitor after editing but did not exists before editing, copying the contents of the cells of that region to the corresponding cells of the changed clone; and
j) for each cell in the progenitor after editing that has been designated as propagating, copying the contents of that cell to the corresponding cell of the changed clone.

9. The method of claim 8 wherein:
a) the corresponding cells in two regions are a cell in the first region and a cell in the second region such that they have same relative offset with respect to the origin of their respective regions; and
b) wherein the contents of a cell is the formula if the cell contains a formula otherwise it is the value of the cell.

10. A computer readable medium having stored thereon computer-executable instructions for performing the method of claim 8.

11. In a multi dimensional spreadsheet a method for selectively summing the values of some of the cells on the spreadsheet comprising:
a) defining a plurality of regions by binding a non-unique symbolic name to a cell or a plurality of cells for each region;
b) a spreadsheet function that has at least two arguments: one argument is the symbolic name of a region that contains the cell that has the formula which uses the spreadsheet function, another argument is a pattern for matching symbolic names; and wherein the value of the spreadsheet function is the sum of the values of all cells of all regions that are contained in the region specified by the symbolic name argument and that have a symbolic name matching the pattern argument.

12. A computer readable medium having stored thereon computer-executable instructions for performing the method of claim 11.
